(19) United States
(12) Patent Application Publication
(10) Pub. No.: US 2004/0258480 A1
(43) Pub. Date: Dec. 23, 2004

(54) Conduit installation tool and method of use thereof

(76) Inventor: James V. Prisby, Orland Park, IL (US)

Correspondence Address: Attention: D. Edward Dolgorukov, Esq., Marshall & Melhorn, LLC, 8th Floor, Four SeaGate, Toledo, OH, 43604, US

(21) Appl. No.: 10/464,912

(22) Filed: Jun. 19, 2003

(51) Int. Cl. F16L 1/06

(52) U.S. Cl. 405/184.4; 254/390; 29/235; 404/74

(57) ABSTRACT

A tubing installation system and method having a length of flexible tubing, a handle having a first end and second end and at least one wheel rotatably mounted to the first end. The at least one wheel has a circumferential portion with a complimentary shape to at least a portion of the tubing and an axis of rotation substantially perpendicular to the handle. The circumferential portion is used to urge the tubing into a tubing recess.

### BACKGROUND OF THE INVENTION

1. Field of the Invention

The present invention relates generally to the installation of tubing or conduit in a channel. More particularly, the present invention relates To a tool for installing tubing or conduit in a channel having a handle where a tool body is attached to one end of the handle, and at least one wheel is attached to the tool body, where the wheel has a complimentary shape to at least a portion of flexible tubing. An operator can use The handle and, optionally, a foot pedal, to use the wheel to urge and direct the tubing into a tubing recess. Most particularly, the invention relates a tool of the foregoing nature, and a method of use thereof, for installation of tubing or conduit in walls, floors, ceilings, and the like, in connection with radiant heating systems.

2. Discussion of the Related Art

Various devices and methods dealing with radiant heating systems are well-known in the art such as, for example, U.S. Patent Nos, 4,074,406; 5,292,065; 5,743,330; 6,283,383; and 6,330,980. While these patents demonstrate activity in the radiant heating area, none of these patents show tools for installing tubing in these systems.

U.S. Pat. No. 6,340,271 provides for a groove wheel placed at the end of an arm. The arm, however, is required to be tangential to the wheel and have an exterior diameter sized to fit within a conventional conduit pipe for stringing cable through conduit.

U.S. Pat. No. 286,861 provides for placing cables in conduit. The conduit is formed in situ in the ground. Wires are placed on a reel and advanced through a tube while the space about the wires is filled with hydraulic cement. The patent provides for manufacturing a tube and placing it in a trench preformed to accept the tube.

Accordingly, it would be advantageous to have a method and apparatus for locating tubing in a tubing recess which overcomes the disadvantages and shortcomings of the prior ar. It would be further advantageous to have a low-cost, low-maintenance apparatus and method to locate tubing in a tubing recess that takes up little room and can be easily repaired. IT would also be advantageous to have such a method and apparatus which is highly maneuverable so that curved tubing recesses can be traced with the apparatus and which allows the operator to remain on his or her feet and thus not have to crawl on the floor.

### SUMMARY OF THE INVENTION

The present invention is an apparatus and method for using a tubing tool. The invention has a handle with a first end and a second end. The second end has a tool body attached thereto. Optionally, a foot pedal may be attached to the rear surface of the tool body, and at least one tubing guide is attached to the front surface of the tool body. The foot pedal may be either a solid plate, or have one or more apertures to save weight. The tubing guide is preferably hook shaped to allow a length of flexible tubing to be easily inserted and released from the guide.

Also attached to the tool body is a downwardly extending fork. At least one wheel is, preferably, rotatably and removably attached to the fork. The wheel preferably has a circumferential portion with a curvilinear surface, The curvilinear surface has a complimentary shape to the flexible tubing. Typically, the curvilinear surface is concave. However, other shapes are well within the scope of the present invention.

An operator guides a length of flexible tubing from a tubing source through the tubing guide and places the tubing adjacent a tubing recess. The operator locates the wheel over the tubing and either through force on the handle or force on the foot pedal, or both, forces the tubing into the tubing recess by rolling the wheel over the tubing.

### BRIEF DESCRIPTION OF THE DRAWINGS

The above, as well as other advantages of the present invention, will become readily apparent to those skilled in the art from the following detailed description when considered in the light of the accompanying drawings in which;

FIG. 1 is a schematic front view of an embodiment of the present invention.

FIG. 2 is a schematic side view of the embodiment depicted in FIG. 1.

FIG. 3 is a schematic top view of the embodiment depicted in FIG. 1.

FIG. 4 is an exploded schematic front view of a portion of the invention depicted in FIG. 1.

FIG. 5 is a schematic perspective view of an embodiment of the present invention.

FIG. 6 is a schematic side view of an alternative embodiment of the present invention.

FIG. 7A is a perspective view, partly broken away, showing one type of channel into which tubing may be installed using the present invention.

FIG. 7B is an elevational view, similar in part to FIG. 7A, showing a piece of tubing in position to be installed into the channel shown in FIG. 7A.

FIG. 7C is an elevational view, very similar to FIG. 7B, showing the tubing installed into the channel by the present invention.

FIG. 8A is a perspective view, partly broken away, showing another type of channel into which tubing may be installed using the present invention.

FIG. 8B is an elevational view, similar in part to FIG. 8A, showing a piece of tubing in position to be installed into the channel shown in FIG. 5A.

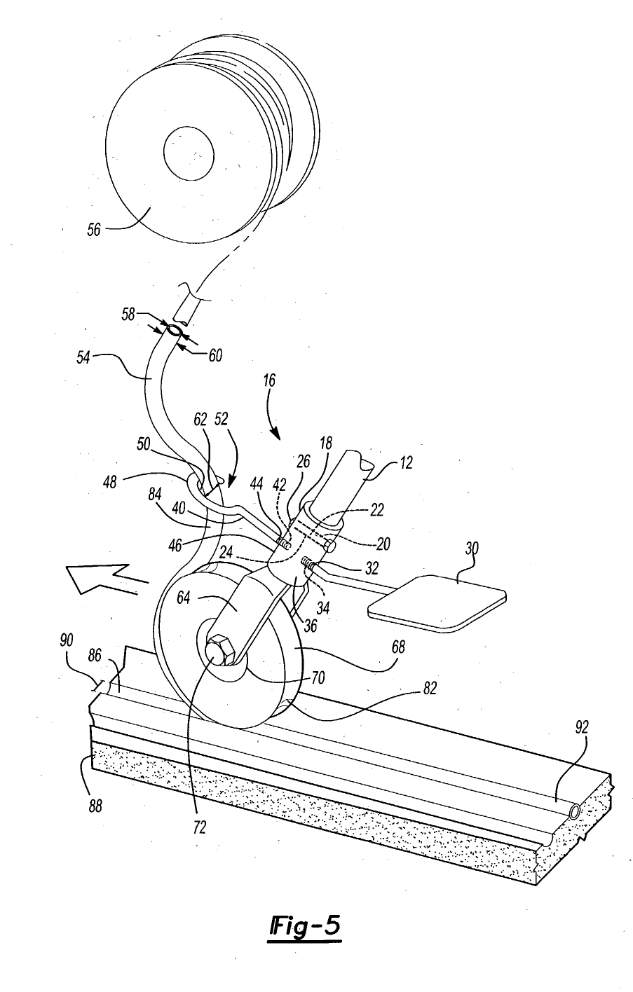

FIG. 5C is an elevations view, very similar to FIG. 8B, showing the tubing installed into the channel by the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defied in the appended claims. Hence, specific dimensions, directions or other physical characteristics relating to the embodiments disclosed are not to be considered as limiting, unless the claims expressly state otherwise.

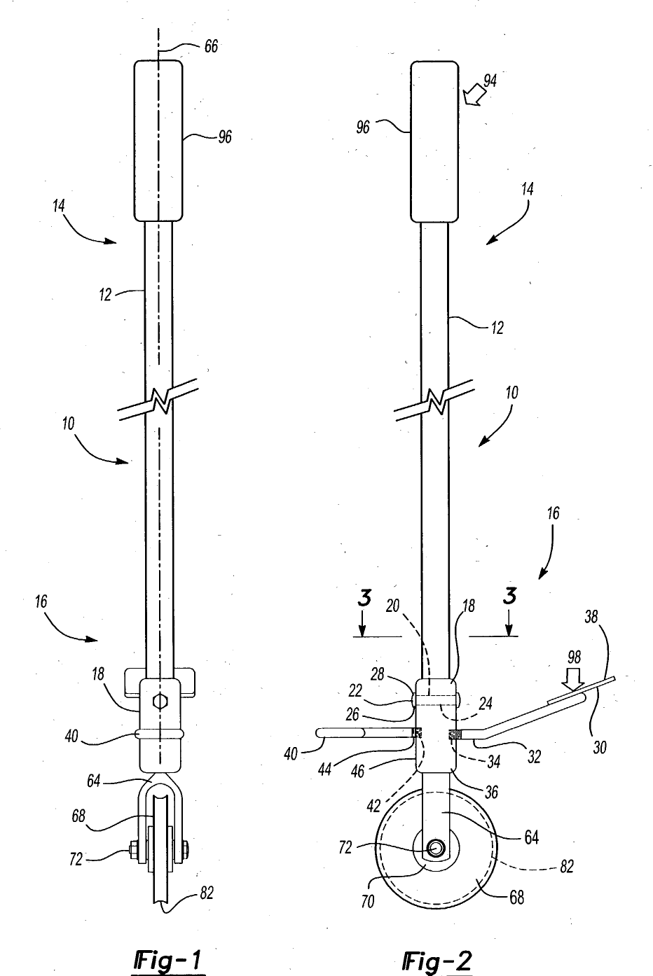

Referring to FIGS. 1, 2 and 3, the conduit or tubing installation tool, indicated generally at 10, preferably has a substantially straight handle 12 with a first end 14, and a second end 16. However, the handle may be offset, or bent, if desired. The handle 12 is preferably constructed of a strong, lightweight material such as, for example, fiberglass. Other lightweight materials, such as plastic may also be used. However, a handle 12 constructed of wood or metal is well within the scope of the present invention. The handle 12 can be any length but preferably it is approximately 1-7 feet long.

A tool body 18 is attached to the second end 16 of handle 12. The tool body 18 may be attached to the handle 12 with an adhesive and/or via friction, bolts, screws, rivets, nails, male and female fittings, or any other mechanical attachment device known to those skilled in the art. The use of suitable adhesive or bonding techniques are also contemplated. Preferably, the tool body 18 has at least one aperture 20 for accommodating at least one bolt 22. The handle 12 has at least one complimentary aperture 24 to the tool body aperture 20. Insertion of the handle 12 into The tool body. 18 aligns the apertures 20, 24 and allows the bolt 22 to be passed through both. A nut 26 is located on the free end 28 of the bolt 22 to secure the bolt 22 within the apertures 20, 24. Thus, it can be appreciated that by removing the nut 26 and bolt 22 that the handle 12 and tool body 18 can be separated for repair or replacement.

In a preferred embodiment, at least one foot pedal 30 is attached to the tool body 18. The foot pedal 30 has a first set of threads 32 which engage a complimentary set of threads 34 on a rearward facing surface 36 of the tool body 18. Thus, the foot pedal 30 can be easily removed and/or attached to the tool body 18 for repair or replacement. Although threaded engagement of the foot pedal 30 with the tool body 18 is the preferred method of attachment, other means of attachment such as, by way of example only, adhesive and/or via fiction, bolts, screws, rivets, nails, male and female fittings or any other mechanical attachment device known to those skilled in the ant may also be used.

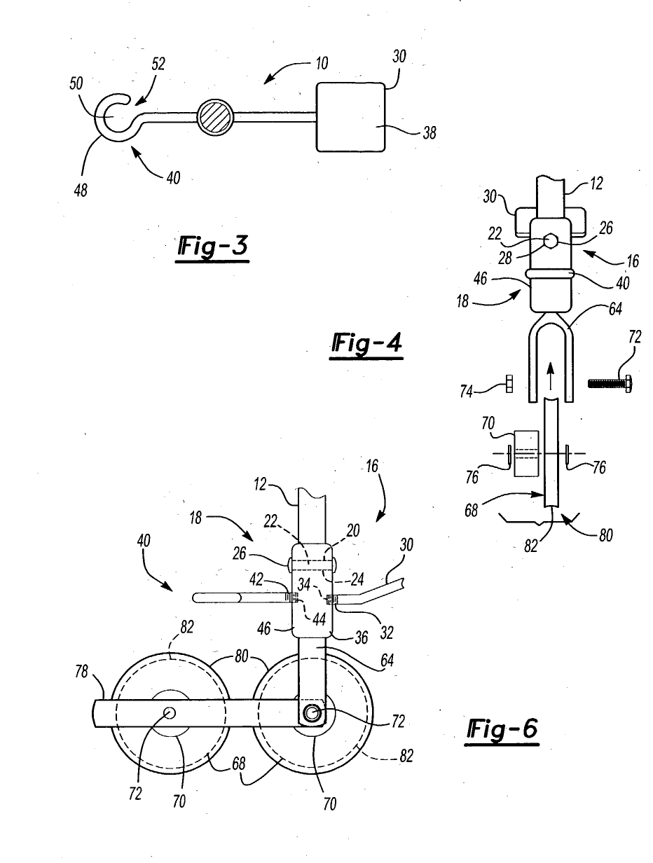

The optional foot pedal 30 may be a substantially solid flat plate 38, as depicted in FIG. 3, or it may have one or more apertures to save weight.

The foot pedal 30 preferably extends rearwardly from The handle 12. The foot pedal 30 may be located at any height from the second end 16 of the handle 12, however, it is preferred that the foot pedal 30 be located at a height proximate the second end of the handle,

Approximately one hundred and eighty degrees around the handle 12 from the foot pedal 30, a tubing guide 40 extends forward from The handle 12. The tubing guide 40 preferably has a first set of threads 42 which engage a complimentary set of threads 44 on a forward facing surface 46 of the tool body 18. Thus, the Tubing guide 40 can be easily removed and/or attached from the tool body 18 for repair or replacement.

Although threaded engagement of the tubing guide 40 with the tool body 18 is the preferred method of attachment, other means of attachment such as, by way of example only, adhesive and/or via friction, bolts, screws, rivets, nails, male and female fittings or any other mechanical attachment device known to those skilled in the art may also be used.

As best seen in FIGS. 3 and 5, the tubing guide 40 is substantially and preferably hook shaped, thus providing the tubing guide 40 with a perimeter portion 48 and a hollow center portion 50. A portion 52 of The perimeter portion 48 is absent to provide the hook shape.

The tubing guide 40 of the present invention, however, is not limited to a hook shape. Instead, the tubing guide 40 may assume any shape haying a channel capable of guiding flexible tubing 54 from a Tubing source 56, such as a spool, To a location as described in more detail below.

The tubing 54 has an inside diameter 58, and an outside diameter 60. The tubing 54 may be any of those suitable for use in radiant heating systems known by those skilled in the art. The tubing 54 is preferably constructed of a plastic material, however, any construction that provides flexibility to the tubing may be used. Preferably, the outside diameter 60 of the tubing is smaller than an inside diameter 62 of the perimeter portion 48 of tubing guide 40.

As depicted in FIGS. 1, 2 and 4, a fork 64 extends from the tool body 18 downward. Preferably, the fork 64 extends downward from the tool body 18 along the axis 66 of the handle 12, however, it is well within the scope of the invention to offset the fork 64 from axis 66.

At least one wheel 68 is rotatably attached to the fork 64. The wheel 68 is rotatably attached to the fork 64 by locating a bearing 70, known to those skilled in the art, in the wheel 68 and locating a bolt 72 through the fork 64 and the bearing 70. A fastener 74, such as a nut, is located on the bolt 72 opposite the bolt head to secure the bolt 72 to the fork 64. One or more washers 76 are located on the bolt 72 in a manner known by those skilled in the art. This design allows the wheel 68 to be easily removed from the fork 64 for repair or replacement.

In an alternative embodiment, the fork 64 may have a portion 78 which extends perpendicularly to the axis 66 of the handle 12 to accommodate more than one wheel 68. The wheels 68 are located along the perpendicularly extending portion 78 of the fork 64 so that each wheel 68 is located substantially behind the preceding wheel 68. The wheels 68 are rotatably attached to the perpendicularly extending portion 78 in a similar fashion to the single wheel 68 described above.

Referring back to FIG. 4, the at least one wheel 68 has a circumferential portion 80 with a curvilinear surface 82. The curvilinear surface 82 preferably has a complimentary shape to at least a portion of an outside surface 84 of the flexible tubing 54 shown in FIG. 5. Typically, the curvilinear surface 82 will be in a concave shape so as to compliment the convex shape of the outside surface 84 of the tubing 54. However, it is well within the scope of the present invention to have a curvilinear surface 892 which is convex, compound or any other shape complimentary shape To the tubing 54.

A method of using The present invention will now be described. A tubing recess 86 is located in, or formed in, a wall, floor, ceiling or any other structure 88 in which tubing 54 is to be located. The tubing 54 is selected to fit in the tubing recess 86, and once installed, is held in place by friction, adhesive, or other means well known in the art. If the tubing 54 is selected to have an outside diameter 60 approximately the same as the inside diameter 90 of the tubing recess 86, and the tubing recess has, for example, a cross section larger than a semi-circle, the tubing 54 must be forced into the tubing recess 86. The flexible nature of the tubing 54 allows for it to be forced into the tubing recess 86 without blocking, breaking, cracking, splitting or otherwise compromising the integrity of the tubing 54.

A length of tubing 54 is provided from the tubing source 56. The free end of the tubing 54 is manually located within the tubing guide 40 using one of two methods. The first method involves threading the free end of the tubing 54 through the hollow portion 50 of the tubing guide 40. The second method involves locating the tubing 54 through the portion 52 that has been removed from the perimeter portion 48. Regardless of the method used, the tubing 54 is located in the hollow portion 50 so that the length of tubing 54 can slide easily therethrough.

The tubing 54 is manually located over the tubing recess 86. The larger outside diameter 60 of the tubing 54, as compared to the diameter 90 of the recess 86 initially prevents the tubing 54 from entering the tubing recess 86. The operator grasps the handle 12 and aligns the curvilinear surface 86 of the wheel 68 with a top surface 92 of the tubing 54.

In one embodiment, the operator supplies a first downward force 94 to the handle 12. The first downward force 94 is transmitted from the handle 12 to the wheel 68 and to the tubing 54. The wheel 68 urges the tubing 54 into the tubing recess 86 using the complimentary curvilinear surface 86 to guide the tubing 54 into the tubing recess 86. The tubing guide 40 aligns the tubing 54 being received from the tubing source 56 with the wheel 68 thus preventing, or reducing, the need for alignment corrections.

One or more hand grips 96 may be located on the handle 12 to facilitate holding and guiding the handle 12 during use. For example, a hand grip 96 may be located at the first end 14 of the handle 12 as depicted in FIGS. 1 and 2.

In another embodiment, the operator can supply an additional, or a separate, second downward force 98 to the wheel 68 by stepping on the foot pedal 30. This second downward force 98 may be necessary to locate tubing 54 in a particularly tight tubing recess 86 or when additional guidance is needed.

In either embodiment, the invention allows the operator to locate tubing 54 within a tubing recess 86 despite the location, orientation or direction of the tubing recess 86.

Once the tubing 54 is located into the tubing recess 86, it expands to the inside diameter 90 of the tubing recess 86 and becomes securely located therein.

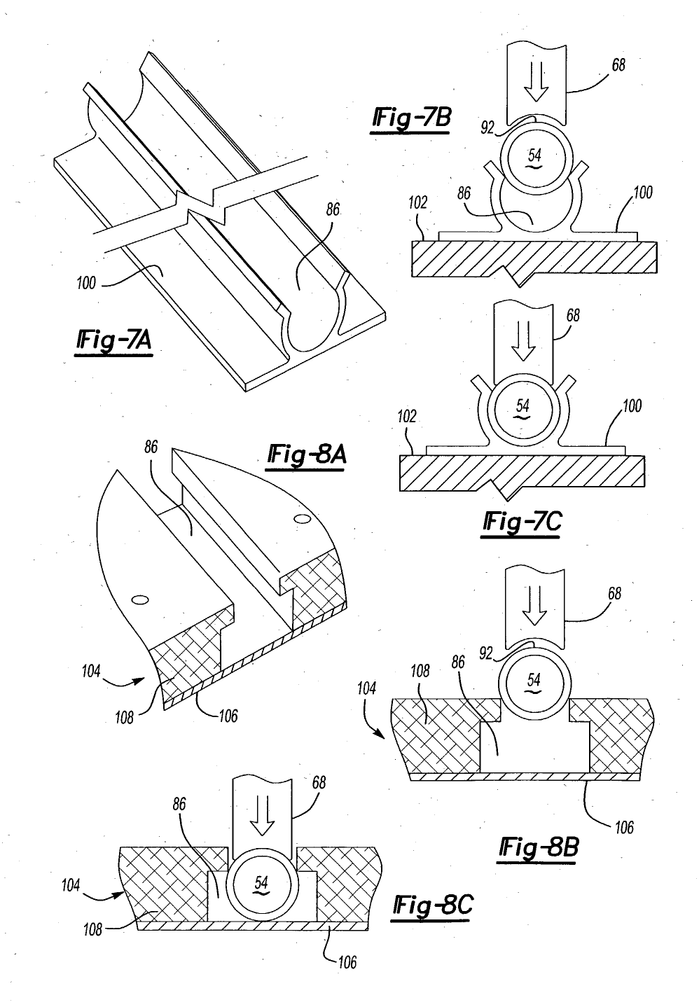

Referring to FIGS. 7A-7C, the use of my invention to install the tubing 54 into a commercially available product is shown. In FIG. 7A is shown a perspective view, partially broken away, of a commercially available extruded product sold under the name Joist Trak™ by Uponor Wirsbo of Apple Valley, Minn.

The Joist Trak™ is a rigid channel, which can be mounted to floors, walls and ceiling to provide for the installation of radiant heat. The channel 100 is mounted to any practical substrate 102, such as a subfloor, and has a tubing recess 86 provided therein. As described hereinabove, to insert the tubing 54, which may be such as hePEX™ also sold by Uponor Wirsbo of Apple Valley, Minn., copper, plastic or any other suitable flexible tubing, the wheel 68 of my improved tubing installation tool 10 is applied to the top surface 92 of the tubing 54, pressure is applied, The tubing 54 “flexes” slightly while moving into the tubing recess 68, and “Snaps” into place. Depending on whether the radiant heat is being placed in a floor, wall, or ceiling, the pressure being applied by my improved tubing installation tool may be applied in an upward, downward, lateral, or any other direction

With reference to FIGS. 8A-8C, there is shown another commercially available flooring product into which my improved tubing installation tool 10 can install tubing 54. This product is known in the trade as Quik Trak™ sold by Uponor Wirsbo of Apple Valley, Minn. This product is a composite 104 having an aluminum layer 106 stamped to the bottom of a dense plywood layer 108 in a manner well known in the art A tubing recess 86 is provided in the composite 104. The installation of the tubing 54 is done as described above.

In accordance with the provisions of the patent statutes, the present invention has been described in what is considered to represent its preferred embodiments, however, it should be noted that the invention can be practiced otherwise than as specifically illustrated and described without departing from its scope or spirit.

I claim:

1. A tubing tool, comprising:
a handle having a first end and a second end; and
a least one wheel rotatably mounted to said second end, said wheel having a circumferential portion with a curvilinear surface complimentary to at least a portion of an outside surface of flexible tubing.

2. The tool of claim 1, wherein said second end has a tool body attached thereto.

3. The tool of claim 2, wherein a foot pedal is attached to said tool body.

4. The tool of claim 2, wherein a tubing guide is attached to said tool body.

5. The tool of claim 2, wherein said at least one wheel is removeably mounted to said tool body.

6. The tool of claim 5 wherein said tool body has at least one pair of forks.

7. The tool of claim 6, wherein said forks removably attach to an axle for said at least one wheel.

8. The tool of claim 4, wherein said tubing guide has a perimeter portion and a hollow center portion.

9. The tool of claim 8, wherein said perimeter portion has a portion removed therefrom.

10. The tool of claim 1, wherein said circumferential portion is concave.

11. A tubing installation system, comprising:
a length of flexible tubing;
a handle having a first end and a second end; and
at least one wheel rotatably mounted to said first end, said wheel having a circumferential portion with a complimentary shape to at least a portion of said tubing and an axis of rotation substantially perpendicular to said handle.

12. The system of claim 11, further comprising a source for said flexible tubing.

13. The system of claim 11, wherein said tubing is radiant heating tubing.

14. The system of claim 11, wherein said first end has a tool body attached thereto.

15. The system of claim 14, wherein a foot pedal is attached to said tool body.

16. The system of claim 14, wherein a tubing guide is attached to said tool body.

17. The system of claim 14, wherein said at least one wheel is removeably mounted to said tool body.

18. The system of claim 17, wherein said tool body has at least one pair of forks.

19. The system of claim 18, wherein said forks removably attach to an axle for said at least one wheel.

20. The system of claim 16, wherein said tubing guide has a perimeter portion and a hollow center portion.

21. The system of claim 20, wherein said perimeter portion has a portion removed therefrom.

22. The system of claim 11, wherein said circumferential portion is concave.

23. A method of installing tubing, comprising:
providing a handle with a first end and a second end;
providing at least one wheel rotatably mounted to said second end, said wheel having a circumferential portion with a curvilinear surface complimentary to at least a portion of an outside surface of flexible tubing; and
using said circumferential portion of said wheel to urge said tubing into a tubing recess.

24. The method of claim 23, wherein said tubing is guided through a tubing guide to said at least one wheel.

25. The method of claim 24, wherein said tubing guide has a perimeter portion and a hollow center portion, said perimeter portion aligning said tubing with said at least one wheel.

26. The method of claim 25, wherein said perimeter portion has a portion removed therefrom allowing said tubing to be selectively removed from said tubing guide.

27. The method of claim 26, wherein said portion removed from said perimeter portion allows said tubing to be selectively located within said tubing guide.

28. The method of claim 23, wherein said curvilinear surface of said wheel guides said tubing into said tubing recess.

29. The method of claim 23, wherein said circumferential portion is concave.

30. The method of claim 23, wherein at least a first manual force is applied to said handle to urge said tubing into said tubing recess.

31. The method of claim 23, wherein a second manual force is applied to a foot pedal attached to said first end to urge said tubing into said tubing recess.

32. The method of claim 23, wherein said at least one wheel is removeably mounted to said second end.

33. A method of installing tubing, comprising:
providing tubing from a tubing source;
providing a handle having a first end and a second end;
providing at least one wheel rotatably mounted to said second end, said wheel having a circumferential portion with a complimentary shape to at least a portion said tubing; and
using said circumferential portion of said wheel to urge said tubing into a tubing recess.

34. The method of claim 33, wherein said tubing is guided trough a tubing guide from said tubing source to said at least one wheel.

35. The method of claim 34, wherein said tubing guide has a perimeter portion and a hollow center portion, said perimeter portion aligning said Tubing from said tubing source with said at least one wheel.

36. The method of claim 35, wherein said perimeter portion has a portion removed therefrom allowing said tubing to be selectively removed from said tubing guide.

37. The method of claim 34, wherein said portion removed from said perimeter portion allows said tubing to be selectively located within said tubing guide.

38. The method of claim 33, wherein said complimentary shape of said wheel guides said tubing into said tubing recess.

39. The method of claim 33, wherein said circumferential portion is concave.

40. The method of claim 33, wherein said tubing source provides a substantially continuous supply of tubing.

41. The method of claim 33, wherein at least a first manual force is applied to said handle to urge said tubing into said tubing recess.

42. The method of claim 33, wherein a second manual force is applied to a foot pedal attached to said first end to urge said tubing into said tubing recess.

43. The method of claim 33, wherein said at least one wheel is removeably mounted to said second end.
